(19) United States
(12) Patent Application Publication
(10) Pub. No.: US 2026/0269458 A1
(43) Pub. Date: Sep. 10, 2026

(54) ANTENNA STRUCTURE AND INTELLIGENT WEARABLE GLASSES

(71) Applicant: GOERTEK TECHNOLOGY CO., LTD, Qingdao, Shandong (CN)

(72) Inventors: Ziheng DING, Qingdao, Shandong (CN); kenichiro KODAMA, Qingdao, Shandong (CN); katsumi SAITO, Qingdao, Shandong (CN)

(21) Appl. No.: 19/164,409

(22) PCT Filed: Aug. 2, 2024
(86) PCT No.: PCT/CN2024/109447

§ 371 Date: Sep. 11, 2025

(30) Foreign Application Priority Data
Aug. 4, 2023 (CN) 202310977509.0

(51) Int. Cl. H01Q 1/27; G02B 27/01; H01Q 1/36

(52) U.S. Cl. CPC H01Q 1/273; G02B 27/017; H01Q 1/36; G02B 2027/0178

(57) ABSTRACT

An antenna structure and intelligent wearable glasses. The antenna structure includes: a carrier, which has a first side surface and a second side surface which are arranged opposite each other, wherein the first side surface is used for fixing a lens; an antenna ground, which is arranged on the second side surface of the carrier; and a broadband monopole, which is arranged on the second side surface of the carrier, wherein the wideband monopole is coupled to the antenna ground. Therefore, the problem of a conventional antenna for AR glasses having a low efficiency is solved.

The present disclosure claims the priority to the Chinese Patent Application No. 202310977509.0, entitled “ANTENNA STRUCTURE AND INTELLIGENT WEARABLE GLASSES”, filed with China Patent Office on Aug. 4, 2023, the entire contents of which are incorporated into the present disclosure by reference.

### TECHNICAL FIELD

The present disclosure relates to a technical field of antenna structure, and more specifically, to an antenna structure and intelligent wearable glasses.

### DESCRIPTION OF RELATED ART

With the rapid development of AR glasses, intelligence, lightweight and the like have become a main development trend of AR glasses. These characteristics impose higher requirements for hardware performance, structure, heat dissipation, appearance, and other aspects of the AR glasses.

A conventional antenna for AR glasses is arranged on a temple, so that it is close to the human head and leaves a limited design space for the antenna, these two factors together result in lower antenna efficiency. An introduction of new materials, such as carbon fiber, brings new challenges to antenna design while reducing weight for AR glasses. For example, the carbon fiber has a certain conductivity, so the carbon fiber cannot be used at the position where the antenna is mounted, which is not conducive to the aesthetics of product. Meanwhile, since the efficiency of the antenna is positively correlated with the bandwidth, aperture area and the like, the reduction of volume of the AR glasses makes the design of antenna more and more difficult, it is difficult to ensure the efficiency and the wideband is also difficult to implement.

### SUMMARY

A main object of the present disclosure is to provide an antenna structure, which aims to solve the problem of low efficiency of the conventional antenna for AR glasses.

To achieve the foregoing objective, the present disclosure provides an antenna structure, including:
a carrier having a first side surface and a second side surface arranged opposite each other, wherein the first side surface is configured to be fixed on the lens;
an antenna ground arranged on the second side surface of the carrier; and
a wideband monopole arranged on the second side surface of the carrier, wherein the wideband monopole is coupled to the antenna ground.

Optionally, the carrier has a shape adapted to that of the lens;
the antenna ground is disposed close to a side edge of the carrier;
the wideband monopole is disposed on a side of the carrier away from the side edge.

Optionally, the antenna ground is disposed around a side edge of the carrier.

Optionally, the antenna ground includes:
a coupling portion, wherein a gap is formed between the coupling portion and the wideband monopole; and
a metal ring, wherein two ends of the metal ring are connected to the coupling portion, and the metal ring is disposed around a side edge of the carrier.

Optionally, the antenna ground further includes a capacitive loading stub disposed on a side of the carrier close to the side edge, wherein the capacitive loading stub is electrically connected to the metal ring, and the capacitive loading stub is configured to match impedance.

Optionally, the capacitive loading stub is made of metal mesh.

Optionally, the coupling portion is U-shaped, and an opening of the coupling portion is disposed at a position corresponding to the wideband monopole.

Optionally, the coupling portion includes a metal layer, an ACF conductive film layer, and a flexible circuit board layer that are sequentially stacked on the carrier;
the metal layer is electrically connected to the metal ring;
the flexible circuit board layer is configured to be electrically connected to an outer conductor of a coaxial cable.

Optionally, the wideband monopole includes:
a feeding coplanar waveguide, wherein a gap is formed between the feeding coplanar waveguide and the antenna ground, and the feeding coplanar waveguide is configured to implement signal transmission; and
a radiation stub electrically connected to the feeding coplanar waveguide, and the radiation stub is configured to match wideband impedance.

Optionally, the radiation stub includes a main stub, a first stub, and a second stub, wherein a first end of the main stub is electrically connected to the feeding coplanar waveguide, and a second end of the main stub is electrically connected to the first stub and the second stub.

Optionally, a length of the first stub is greater than a length of the second stub.

Optionally, the radiation stub is made of metal mesh.

Optionally, the feeding coplanar waveguide includes a metal layer, an ACF conductive film layer, and a flexible circuit board layer that are sequentially stacked on the carrier;
the metal layer is electrically connected to the radiation stub;
the flexible circuit board layer is configured to be electrically connected to an inner conductor of a coaxial cable.

The present disclosure also provides intelligent wearable glasses, including:
a frame;
a lens disposed in the frame; and
the antenna structure as described above, wherein the antenna structure is disposed on the lens.

According to the technical solution of the present disclosure, the antenna structure is moved from the temple to the lens without occupying an internal space of the intelligent wearable glasses, so that the design of the antenna structure is not limited by the internal space of the glasses, and since the efficiency of the antenna is positively correlated with the bandwidth and aperture area, disposing the antenna structure on the lens can increase the aperture area of the antenna, thereby improving the antenna efficiency and improving the transmission capability of the wireless communication system of the AR glasses. Meanwhile, moving the antenna structure from the temple to the lens allows the antenna to be farther away from the human head, resulting in higher efficiency compared to traditional antenna for AR glasses. In addition, since the carbon fiber has a certain electrical conductivity, the position where the antenna is mounted cannot adopt the carbon fiber, while in the present disclosure, the antenna structure is arranged on the lens so that a housing of the intelligent wearable glasses can be made of carbon fiber, which not only reduces the weight of the intelligent wearable glasses, but also ensures the aesthetics of the intelligent wearable glasses.

### BRIEF DESCRIPTION OF DRAWINGS

In order to more clearly illustrate the embodiments of the present disclosure or the technical solutions in the prior art, the drawings required to be used for the content of the embodiments or the prior art will be briefly introduced in the following. Obviously, the drawings in the following description are merely a part of the drawings of the present disclosure, and for those of ordinary skill in the art, other drawings can also be obtained from the provided drawings without any creative effort.

FIG. 1 is a schematic structural diagram of intelligent wearable glasses according to an embodiment of the present disclosure;

FIG. 2 is a structural front view of an antenna structure according to an embodiment of the present disclosure;

FIG. 3 is a structural side view of an antenna ground in the antenna structure according to an embodiment of the present disclosure;

FIG. 4 is a structural side view of a wideband dipole in the antenna structure according to an embodiment of the present disclosure;

FIG. 5 is a structural front view of intelligent wearable glasses according to an embodiment of the present disclosure;

FIG. 6 is a graph of simulated input impedance with respect to frequency of the antenna structure according to an embodiment of the present disclosure;

FIG. 7 is a diagram showing a surface current distribution at the frequency of 1.5 GHz for the antenna structure according to an embodiment of the present disclosure;

FIG. 8 is a diagram showing a surface current distribution at the frequency of 2.46 GHz for the antenna structure according to an embodiment of the present disclosure;

FIG. 9 is a diagram showing a surface current distribution at the frequency of 5 GHz for the antenna structure according to an embodiment of the present disclosure;

FIG. 10 is a diagram showing a surface current distribution at the frequency of 6.5 GHz for the antenna structure according to an embodiment of the present disclosure;

FIG. 11 is a diagram showing a surface current distribution at the frequency of 7.6 GHz for the antenna structure according to an embodiment of the present disclosure;

FIG. 12 is a diagram showing a surface current distribution at the frequency of 8.5 GHz for the antenna structure according to an embodiment of the present disclosure;

FIG. 13 is a graph of measured S1,1 with respect to frequency of the antenna structure according to an embodiment of the present disclosure;

FIG. 14 is a graph of measured efficiency with respect to frequency when the antenna structure is placed on a human head model according to an embodiment of the present disclosure.

The reference numerals in the drawings are follows:

| Reference | | Reference | |
|---|---|---|---|
| numeral | Name | numeral | Name |
| 10 | Antenna Ground | 12 | Metal Ring |
| 20 | Wideband Monopole | 13 | Capacitive loading stub |
| 30 | Carrier | 21 | Feeding coplanar |
| | | | waveguide |
| 11 | Coupling Portion | 22 | Radiation stub |

### DETAILED DESCRIPTIONS

Technical solutions of embodiments of the present disclosure will be described below with reference to the drawings in the embodiments of the present disclosure. Obviously, the described embodiments are only a part of the embodiments of the present disclosure, rather than all the embodiments. Based on the embodiments in the present disclosure, all other embodiments obtained by those of ordinary skill in the art without creative efforts shall fall within the protection scope of the present disclosure.

At present, a conventional antenna for AR glasses is arranged on a temple, so that it is close to the human head and leaves a limited design space for the antenna, these two factors together result in lower antenna efficiency. An introduction of new materials, such as carbon fiber, brings new challenges to antenna design while reducing weight for AR glasses. For example, the carbon fiber has a certain conductivity, so the carbon fiber cannot be used at the position where the antenna is mounted, which is not conducive to the aesthetics of product. Meanwhile, since the efficiency of the antenna is positively correlated with the bandwidth, aperture area and the like, the reduction of volume of the AR glasses makes the design of antenna more and more difficult, it is difficult to ensure the efficiency and the wideband is also difficult to implement.

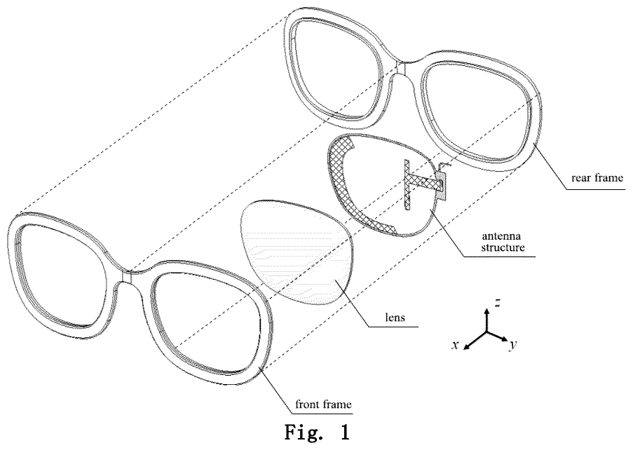

In order to solve the above problems, the applicant has conducted long-time experiments, simulations and verifications, and proposed an antenna structure, which is applied to intelligent wearable glasses including lenses. Referring to FIG. 1 to FIG. 3, in an embodiment, the antenna structure includes:
a carrier 30 having a first side surface and a second side surface opposite to each other, the first side surface being configured to be fixed to the lens;
an antenna ground 10 arranged on the second side surface of the carrier 30; and
a wideband monopole 20 arranged on the second side surface of the carrier 30, wherein the wideband monopole 20 is coupled to the antenna ground 10.

In this embodiment, the carrier 30 may be an antenna carrier 30 made of a thin film material or the like and configured to cover the lens, the carrier 30 may be attached to the lens by means of an optical adhesive or the like, and the carrier 30 may also be other carriers originally attached to the lens, such as a blue light film, a dustproof film, etc. on the lens. It may be understood that the lens is generally made of a material such as polycarbonate, and has relatively high hardness, and it is difficult to directly attach the antenna structure to the lens, so a layer of carrier 30, such as PET (polyethylene terephthalate) film, may be attached to the lens and then the antenna structure may be arranged on the carrier 30, so that the antenna can be more stably placed on the lens. The wideband monopole 20 and the antenna ground 10 may be connected to a radio frequency module in a temple of the intelligent wearable glasses through a feeder coaxial cable, and current introduced by the feeder coaxial cable can form a current distribution on the wideband monopole 20 and the antenna ground 10, thereby forming a radiation field in space and radiating electromagnetic waves outward so as to implement communication with the outside.

In addition, considering the visual effect of the intelligent wearable glasses, the antenna structure can be designed to achieve a visual transparency effect. For example, a ground feeding portion of the antenna needs to be implemented by using a conductive metal with good conductivity, but the conductive metal with high conductivity usually has low light transmittance and cannot achieve the visual transparency effect. Accordingly, the antenna ground 10 may be provided to have a ring shape and disposed in an edge portion of the lens to surround the lens, as such, the antenna ground 10 can be hidden in the frame of the glasses, so that human eyes cannot see the antenna ground 10 blocked by the frame, and the wideband monopole 20 and the capacitive loading stub 13 that cannot be hidden in the frame may be implemented by using a transparent metal or a metal mesh, thereby achieving a visual transparency effect.

According to the technical solution of the present disclosure, the antenna structure is moved from the temple to the lens without occupying an internal space of the intelligent wearable glasses, so that the design of the antenna structure is not limited by the internal space of the glasses, and since the efficiency of the antenna is positively correlated with the bandwidth and aperture area, disposing the antenna structure on the lens, compared to being placed in the temple, can increase the aperture area of the antenna due to a larger area of the lens, thereby improving the antenna efficiency and improving the transmission capability of the wireless communication system of the AR glasses. Meanwhile, moving the antenna structure from the temple to the lens allows the antenna to be farther away from the human head, resulting in higher efficiency compared to traditional antenna for AR glasses. In addition, the antenna structure is arranged on the lens so that a housing of the intelligent wearable glasses can be made of carbon fiber, which not only reduces the weight of the intelligent wearable glasses, but also ensures the aesthetics of the intelligent wearable glasses.

Referring to FIG. 1 to FIG. 3, in an embodiment, the carrier 30 has a shape adapted to that of the lens;
the antenna ground 10 is disposed close to a side edge of the carrier 30; and
the wideband monopole 20 is disposed on a side of the carrier 30 away from the side edge.

In this embodiment, the shape of the carrier 30 may be adapted to the lens, that is, the shape of the carrier 30 is set to be the same as the shape of the lens, so that the carrier 30 may exactly cover the lens and be attached thereto, and meanwhile, in addition to playing a role of carrying the antenna, the carrier 30 may also be made of a corresponding material, and the carrier 30 may be provided as a blue light film or the like, so as to improve user experience. It may be understood that the ground feeding portion of the antenna needs to be implemented by using a conductive metal with good conductivity, but the conductive metal with high conductivity usually has low light transmittance and cannot achieve the visual transparency effect. Accordingly, considering the visual effect of the intelligent wearable glasses, in this embodiment, the antenna ground 10 may be disposed close to a side edge of the carrier 30, that is, the antenna ground 10 is disposed in an edge position of the lens. As such, when assembling the intelligent wearable glasses, the antenna ground 10 can be hidden in the frame of the glasses, so the opaque metal can be hidden in the frame and cannot be perceived by human eyes, thereby achieving the visual transparency effect. For example, the antenna ground 10 may be disposed on a side of the lens close to a joint between the frame and the temple, and a space at the joint between the frame and the temple is relatively large, which facilitates design and hiding of the antenna ground 10. One end of the wideband monopole 20 is disposed close to a side edge of the carrier 30 to be coupled to the antenna ground 10, the other end of the wideband monopole 20 may extend to a side of the carrier 30 away from the side edge to form a radiation stub 22, and the wideband monopole 20 may be implemented by using a transparent metal or a metal mesh to achieve a visual transparency effect.

Optionally, the antenna ground 10 is disposed around a side edge of the carrier 30.

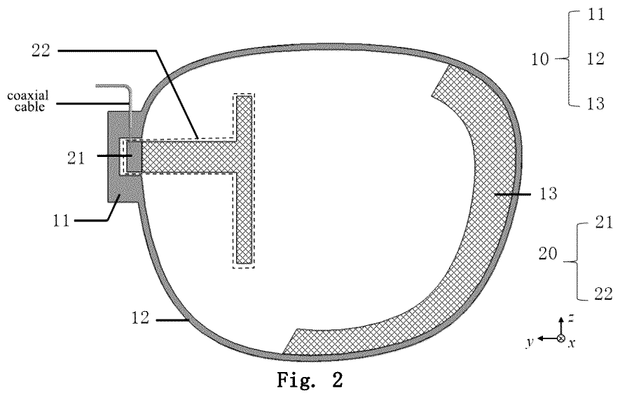

In an embodiment, the antenna ground 10 may be arranged in a ring shape and arranged around a side edge of the carrier 30, that is, the antenna ground 10 is disposed around an edge of the lens in a circle. Referring to FIG. 2, which is a structural front view of an antenna structure according to an embodiment of the present disclosure, the antenna ground 10 is arranged in a ring shape at the edge of the lens, and in this way, when assembling the intelligent wearable glasses, the antenna ground 10 may be hidden in the frame of the glasses, so the opaque metal can be hidden in the frame and cannot be perceived by human eyes, thereby achieving the visual transparency effect.

Referring to FIG. 1 to FIG. 3, in an embodiment, the antenna ground 10 includes:
a coupling portion 11, wherein a gap is formed between the coupling portion 11 and the wideband monopole 20; and
a metal ring 12 electrically connected to the coupling portion 11, wherein the metal ring 12 is disposed around a side edge of the carrier 30.

In this embodiment, the antenna ground 10 may be divided into two parts, that is, the coupling portion 11 and the metal ring 12, a gap is formed between the coupling portion 11 and the wideband monopole 20, for the coupling of the coupling portion 11 and the metal ring 12, so that feed may be formed to implement signal communication and transmission. The metal ring 12 is disposed around a side edge of the carrier 30, that is, disposed around an edge of the lens, and performs radiation together with the coupling portion 11 and the wideband monopole 20 to generate a low-frequency resonance point. In addition, considering the efficiency of the antenna structure, when an electrical length of the metal ring 12 is a wavelength of the transmission signal with the lowest frequency, the performance of the antenna is optimal.

Optionally, the antenna ground 10 further includes:
a capacitive loading stub 13 disposed on a side of the carrier 30 close to the side edge, wherein the capacitive loading stub 13 is electrically connected to the metal ring 12, and the capacitive loading stub 13 is configured to match impedance.

It may be understood that, when the intelligent wearable glasses to which the antenna structure is applied are different, sizes of lenses on the intelligent wearable glasses are different, and the larger the size of the lens, the longer the circumference of the antenna ground 10 accordingly, which indicates a smaller resonant frequency, that is, the resonant frequency of the antenna is affected by the size of the lens. Therefore, in an embodiment, the antenna ground 10 further includes a capacitive loading stub 13 configured to adjust impedance of the antenna ground 10, so that the resonant frequency of the antenna is adjusted. The area of the capacitive loading stub 13 may be set according to actual application requirements, and the larger the lens, the smaller the resonant frequency of the antenna, and the area of the capacitive loading stub 13 should be set larger, thereby increasing the resonant frequency of the antenna, so that the antenna operates in a required frequency band range.

Optionally, the capacitive loading stub 13 is made of metal mesh.

The capacitive loading stub 13 is arranged inside the metal ring 12 and cannot be hidden by the frame of the intelligent wearable glasses, therefore, considering the visual effect of the intelligent wearable glasses, the capacitive loading stub 13 may be made of metal mesh to achieve a visual transparency effect. The parameter of the metal mesh may be set according to actual application requirements, and in a preferred embodiment, the metal mesh has a line width of 6 um, a line thickness of 2 um, and a line spacing of 130 um. In addition, in the intelligent wearable glasses, a central region of the lens is generally used as a display region, so the capacitive loading stub 13 may be disposed at a position close to the edge of the lens to avoid affecting the display region, and meanwhile, the capacitive loading stub 13 may be disposed at the farthest distance from the wideband monopole 20 to avoid affecting the operating frequency and efficiency of the antenna due to coupling.

Referring to FIG. 1 to FIG. 3, in an embodiment, the coupling portion 11 is U-shaped, and an opening of the coupling portion 11 is disposed at a position corresponding to the wideband monopole 20.

Optionally, the coupling portion 11 includes a metal layer 11A, an ACF conductive film layer 11B, and a flexible circuit board layer 11C that are sequentially stacked on the carrier 30; wherein,
the metal layer 11A is electrically connected to the metal ring 12;
the flexible circuit board layer 11C is configured to be electrically connected to an outer conductor of a coaxial cable.

Referring to FIG. 2, FIG. 2 is a structural front view of an antenna structure according to an embodiment of the present disclosure. As illustrated in the figure, the coupling portion 11 is U-shaped, and a feeding coplanar waveguide 21 of the wideband monopole 20 is arranged corresponding to the opening of the coupling portion 11, and providing the coupling portion 11 in a U-shape, on the one hand, is conducive to hiding the coupling portion 11 and the feeding coplanar waveguide 21 of the wideband monopole 20 in the frame to achieve the visual transparency effect, and on the other hand, allows three sides of the feeding coplanar waveguide 21 all to correspond to the coupling portion 11, which can effectively improve the coupling effect between the wideband monopole 20 and the coupling portion 11, thereby improving the efficiency of the antenna. In order to realize the electrical connection with the coaxial cable, referring to FIG. 4, which is a side view of the antenna ground 10 according to an embodiment of the present disclosure, the coupling portion 11 is provided as a three-layered structure, including a metal layer 11A, an ACF conductive film layer 11B and a flexible circuit board layer 11C which are sequentially stacked, the metal layer 11A is configured to be electrically connected with the metal ring 12, the ACF conductive film layer 11B is configured to realize the adhesion and conduction between the metal layer 11A and the flexible circuit board layer 11C, and the flexible circuit board layer 11C is configured for soldering the outer conductor of the coaxial cable to realize the electrical connection between the metal ring 12 and the outer conductor of the coaxial cable. The metal layer 11A may be implemented by using a conductive metal, and the ACF conductive film layer 11B may be implemented by using a material such as an anisotropic conductive film (ACF).

Referring to FIG. 1 to FIG. 3, in an embodiment, the wideband monopole 20 includes:
a feeding coplanar waveguide 21, wherein a gap is formed between the feeding coplanar waveguide 21 and the antenna ground 10, and the feeding coplanar waveguide 21 is configured to implement signal transmission; and
a radiation stub 22, wherein the radiation stub 22 is electrically connected to the feeding coplanar waveguide 21, and the radiation stub 22 is configured to match wideband impedance.

In this embodiment, the wideband monopole 20 may be divided into two parts, that is, the feeding coplanar waveguide 21 and the radiation stub 22. The feeding coplanar waveguide 21 is configured to be coupled to the antenna ground 10 to form feed, thereby implementing signal communication and transmission. The radiation stub 22 performs radiation together with the feeding coplanar waveguide 21 and the antenna ground 10 and is configured to implement wideband impedance matching.

Optionally, the radiation stub 22 includes a main stub, a first stub, and a second stub, wherein a first end of the main stub is electrically connected to the feeding coplanar waveguide 21, and a second end of the main stub is electrically connected to the first stub and the second stub.

Optionally, a length of the first stub is greater than a length of the second stub.

Referring to FIG. 2, FIG. 2 is a structural front view of the antenna structure according to an embodiment of the present disclosure. As illustrated in the figure, the radiation stub 22 may be divided into a main stub, a first stub, and a second stub, where the main stub extends toward the inside of the lens and extends in different directions to form the first stub and the second stub, and a length of the first stub is greater than a length of the second stub, so as to generate resonance points of different frequency bands. The first stub which is longer is configured to generate a low-frequency resonance point in a high-frequency band, and the second stub which is shorter is configured to form a high-frequency resonance point in the high-frequency band.

Optionally, the radiation stub 22 is made of metal mesh.

Since the radiation stub 22 is disposed on an inner side of the antenna ground 10 and cannot be hidden by the frame of the intelligent wearable glasses, considering a visual effect of the intelligent wearable glasses, the radiation stub 22 may be made of metal mesh to implement a visual transparency effect. The parameter of the metal mesh may be set according to actual application requirements, and in a preferred embodiment, the metal mesh has a line width of 6 um, a line thickness of 2 um, and a line spacing of 130 um. In addition, in the intelligent wearable glasses, a central region of the lens is generally used as a display region, so the radiation stub 22 may be disposed at a position close to the edge of the lens to avoid affecting the display region, for example, the radiation stub 22 shown in FIG. 2 is disposed in a T shape.

In an embodiment, the feeding coplanar waveguide 21 includes a metal layer 21A, an ACF conductive film layer 21B, and a flexible circuit board layer 21C sequentially stacked on the carrier 30; wherein,
the metal layer 21A is electrically connected to the radiation stub 22; and
the flexible circuit board layer 21C is configured to be electrically connected to an inner conductor of a coaxial cable.

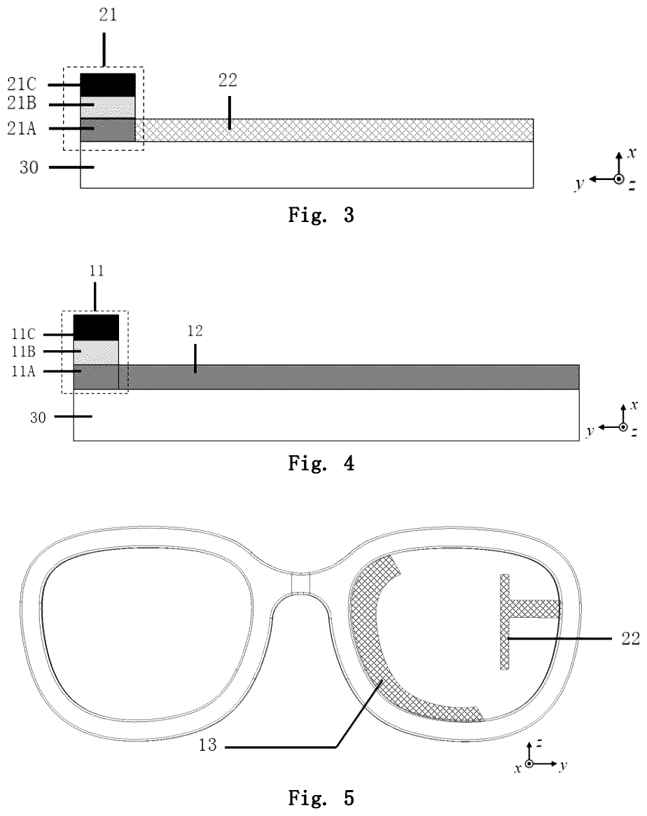

In order to realize the electrical connection with the coaxial cable, referring to FIG. 3, which is a side view of a wideband monopole 20 according to an embodiment of the present disclosure, the feeding coplanar waveguide 21 is provided in a three-layered structure, including a metal layer 21A, an ACF conductive film layer 21B and a flexible circuit board layer 21C which are sequentially stacked, the metal layer 21A is configured to be electrically connected with the radiation stub 22, the ACF conductive film layer 21B is configured to realize the adhesion and conduction between the metal layer 21A and the flexible circuit board layer 21C, and the flexible circuit board layer 21C is configured for soldering the inner conductor of the coaxial cable to realize the electrical connection between the radiation stub 22 and the inner conductor of the coaxial cable. The metal layer 21A may be implemented by using a conductive metal, and the ACF conductive film layer 21B may be implemented by using a material such as an anisotropic conductive film (ACF).

The present disclosure also provides intelligent wearable glasses, including:
a frame and a temple;
a lens disposed in the frame; and
the antenna structure as described above, wherein the antenna structure is disposed on the lens.

In some embodiments, referring to FIG. 1, the intelligent wearable glasses include a front frame, a lens, an antenna structure, and a rear frame. The antenna structure is located inside the lens and adhered to the lens, the lens serves as a dielectric substrate of the antenna structure, and the lens and the transparent antenna are located between the front frame and the rear frame and are clamped and fixed inside the frames.

In order to better illustrate the application concept of this application, the working principle of this application will be explained below in conjunction with specific embodiments and structural diagrams of the antenna structure.

Referring to FIG. 2, FIG. 2 is a structural front view of the antenna structure according to an embodiment of the present disclosure, including a wideband monopole 20, an antenna ground 10, a feeder coaxial cable, and a polyethylene terephthalate (PET) film. Referring to FIG. 2, the wideband monopole 20 includes a radiation stub 22 and a feeding coplanar waveguide 21, the radiation stub 22 includes a main stub, a first stub, and a second stub, the main stub extends toward the inside of the lens and extends in different directions to form the first stub and the second stub, and a length of the first stub is greater than a length of the second stub, so as to generate resonance points of different frequency bands. The longer first stub is configured to generate a low-frequency resonance point in a high-frequency band, and the shorter second stub is configured to form a high-frequency resonance point in the high-frequency band. FIG. 3 shows a side view of the wideband monopole 20, where the feeding coplanar waveguide 21 includes three layers: a metal layer, an ACF conductive film layer, and a flexible circuit board layer, and the three layers are laminated together by using an ACF process, that is, the metal layer and the flexible circuit board layer are adhered together by using an ACF conductive material to form an electrical connection. The radiation stub 22 is implemented by using metal mesh, and in a specific embodiment, the metal mesh preferably has a line width of 6 um, a line thickness of 2 um, and a line spacing of 130 um, so as to achieve a visual transparency effect. And, the metal layer of the feeding coplanar waveguide 21 is connected with the metal mesh portion, so as to facilitate ACF lamination.

Referring to FIG. 2, FIG. 2 is a structural front view of the antenna structure according to an embodiment of the present disclosure, an antenna ground 10 is designed along an edge of a lens, and the antenna ground 10 is composed of a metal ring 12, a capacitive loading stub 13, and a U-shaped coupling portion 11, and a gap is formed between the coupling portion 11 and the wideband monopole 20 for the coupling of the coupling portion 11 and the metal ring 12, so that a power supply may be formed to implement signal communication and transmission. The metal ring 12 is disposed around a side edge of the carrier 30, that is, disposed around an edge of the lens, and performs radiation together with the coupling portion 11 and the wideband monopole 20 to generate a low-frequency resonance point, and an electrical length of the metal ring 12 is preferably one wavelength of the transmission signal with the lowest frequency, and the capacitive loading stub 13 is configured to implement impedance matching. The coupling portion 11 is U-shaped, the feeding coplanar waveguide 21 of the wideband monopole 20 is disposed corresponding to an opening of the coupling portion 11, and providing the coupling portion 11 in a U-shape, on the one hand, is conducive to hiding the coupling portion 11 and the feeding coplanar waveguide 21 of the wideband monopole 20 in the frame to achieve the visual transparency effect, and on the other hand, allows three sides of the feeding coplanar waveguide 21 all to correspond to the coupling portion 11, which can effectively improve the coupling effect between the wideband monopole 20 and the coupling portion 11, thereby improving the efficiency of the antenna. In a specific embodiment, the metal ring 12 is implemented by a conductive metal, the capacitive loading stub 13 is implemented by metal mesh, and the metal mesh preferably has a line width of 6 um, a line thickness of 2 um, and a line spacing of 130 um.

FIG. 4 shows a side view of the antenna ground 10, where the U-shaped coupling portion 11 includes three layers: a metal layer, an ACF conductive film layer, and a flexible circuit board layer, and the three layers are laminated together by using an ACF process. The metal ring 12, the capacitive loading stub 13, and the metal layer of the U-shaped coupling portion 11 are connected to each other. In addition, the inner conductor of the coaxial cable is connected with the flexible circuit board layer of the feeding coplanar waveguide 21 by soldering, and the outer conductor of the coaxial cable is connected with the flexible circuit board layer of the coupling portion 11 by soldering. The PET film is a carrier 30 for the transparent antenna metal, is transparent and colorless, and preferably has a thickness of 100 um. The wideband monopole 20 and the antenna ground 10 are attached on the PET film, and a glue is provided below the PET film to adhere it to the lens. FIG. 5 shows a front view of the intelligent wearable glasses. Since the frame has a certain thickness, the opaque metal is hidden in the frame and cannot be perceived by the human eye. In addition, the feeding coplanar waveguide 21 of the wideband monopole 20 and the antenna ground 10 are also located inside the frame, and are not perceived by human eyes.

The working principle of the antenna structure of the present disclosure is as follows:

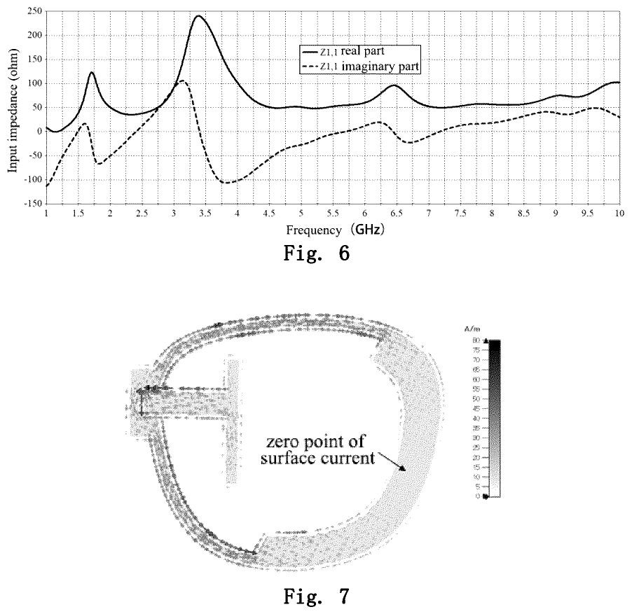

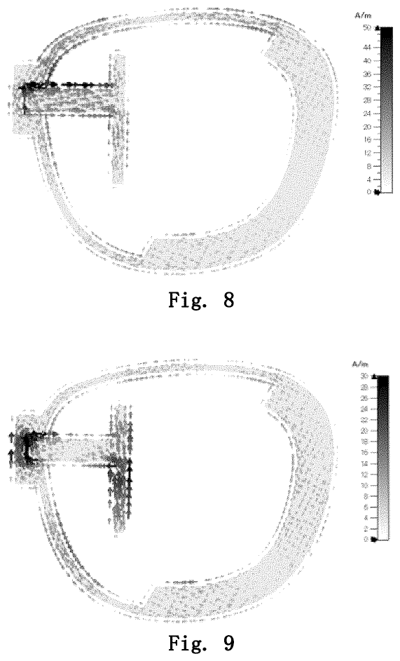

The transparent antenna in the present disclosure includes a wideband monopole 20 and an antenna ground 10. FIG. 6 is a graph of simulated input impedance with respect to frequency of the transparent antenna of the present disclosure. It can be seen that the lowest resonant frequency of the antenna is near 1.5 GHz, and a corresponding electrical length of the antenna ground 10 is one wavelength. FIG. 7 is a diagram showing a surface current distribution of the antenna at the frequency of 1.5 GHz. It can be seen that the surface current is mainly concentrated at the antenna ground 10, while the surface current of the wideband monopole 20 is weak, which indicates that the resonance point is generated by the antenna ground 10; and that the surface current of the antenna ground 10 has two extreme points, which indicates that the antenna ground 10 is in an operating mode of one wavelength at the frequency point of 1.5 GHz, and an input impedance seen from the feed point is an open circuit point, which also corresponds to an input impedance result in FIG. 6. FIG. 8 is a diagram showing a surface current distribution of the antenna at the frequency of 2.46 GHz. At the frequency point of 2.46 GHz, the wideband monopole 20 may couple energy to the antenna ground 10, so the current on the wideband monopole 20 is also strong. In this case, the electrical length of the antenna ground 10 is 1.5 wavelengths, and an input impedance seen from the feed point is a short-circuit point, which corresponds to the input impedance result in FIG. 6. Since the impedance of the short-circuit point is small, in order to make the antenna have good impedance matching at this frequency point, the capacitive loading stub 13 is introduced to adjust its input impedance to 50 ohms. In general, both low frequency resonance points at 1.5 GHz and 2.4 GHz are generated by the antenna ground 10.

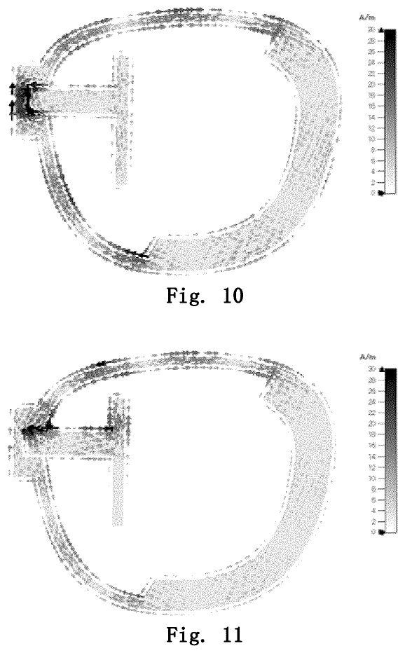

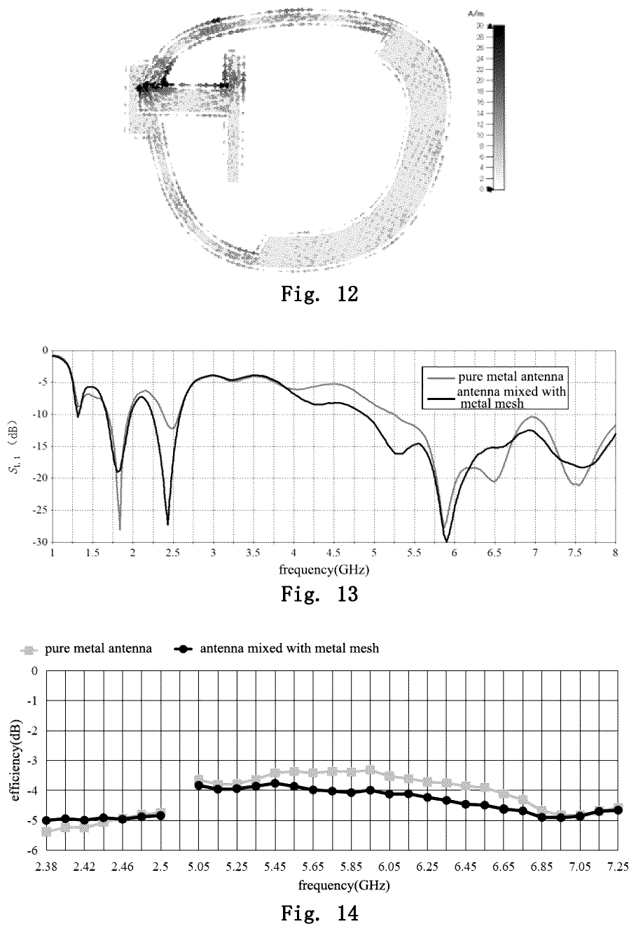

FIG. 9 is a diagram showing a surface current distribution of the antenna at the frequency of 5 GHz. Obviously, unlike the low-frequency surface current distribution, the current of the antenna ground 10 is weak, the current of the wideband monopole 20 is strong and is mainly concentrated in the first stub of the wideband monopole 20, and an electrical length of the first stub of the monopole is half a wavelength. Accordingly, the resonance point is generated by the first stub of the wideband monopole 20. FIG. 10 is a diagram showing a surface current distribution of the antenna at the frequency of 6.5 GHz. Obviously, the current of the antenna ground 10 is strong, the length is 4 wavelengths, and the input impedance is an open circuit point, which corresponds to the input impedance result in FIG. 6. Accordingly, the resonance point is generated by the antenna ground 10. FIG. 11 and FIG. 12 show surface current distribution at frequencies of 7.6 GHz and 8.5 GHz, respectively, and in this case, both the wideband monopole 20 and the antenna ground 10 have strong surface current distribution and they perform radiation jointly.

Generally, the transparent antenna in this application is a multimode antenna including a wideband monopole 20 and a loop antenna. At a low frequency point, the antenna performs radiation by the antenna ground 10, while a high frequency resonance point is alternately generated by the wideband monopole 20 and the antenna ground 10, and the two overlap each other at some high frequency resonance frequencies, so that the operating bandwidth of the antenna is very wide.

In addition, for the problem of high conductor loss of the transparent antenna, in the present disclosure, the transparent antenna adopts an implementation of mixing metal mesh in the structure of the antenna ground 10, that is, the part hidden in the frame is realized by pure metal, and the part exposed in the field of view of human eyes is realized by metal mesh. Such design method can increase an effective cross-sectional area of the metal of the antenna ground 10 without affecting the light transmittance of the transparent antenna. It can be learned from the following formula R=ρ*L/(W*h) (where ρ is the conductivity, L is the length of the conductor, and W*h is the cross-sectional area of the conductor) that, a metal loss of the antenna ground 10 can be greatly reduced. Furthermore, it can be learned from the foregoing analysis on the working principle of the antenna that low-frequency radiation of the antenna depends on the antenna ground 10, and therefore efficiency of the antenna at a low frequency is relatively high. In addition, the electrical length of the wideband monopole 20 in the antenna is 0.5 wavelengths, so compared with about one wavelength in a conventional terminal antenna, the antenna in this application has a smaller electrical length at a high frequency, and a conductor loss after the introduction of the metal mesh is lower, and correspondingly, the high frequency efficiency is also improved.

FIG. 13 is a graph of measured S1,1 with respect to frequency when the antenna of the intelligent wearable glasses is placed on a human head model according to an embodiment of the present disclosure. When |S1,1|≤−10 dB, an operating frequency band of the antenna is 1.67 GHz to 1.98 GHz, 2.24 GHz to 2.59 GHz, and 4.87 GHz to 8 GHz; and when |S1,1|≤−6 dB, an operating frequency band of the antenna is 1.54 GHz to 2.7 GHz, and 3.92 GHz to 8 GHz. FIG. 13 also shows test results of a pure metal antenna with the same structure and size. The performance of the transparent antenna described in this application is substantially the same as that of the pure metal antenna. In addition, compared with a conventional terminal antenna such as a LOOP antenna, a dipole antenna, or a monopole antenna, the antenna in this application has a simpler structure and a wider bandwidth, and can cover mobile communication frequency bands such as Bluetooth and wifi6e/7.

FIG. 14 is a graph of measured efficiency with respect to frequency when the antenna of the intelligent wearable glasses is placed on a human head model according to an embodiment of the present disclosure. In a frequency band of 2.38 GHz to 2.5 GHz, the antenna efficiency is −4.84 dB to −5 dB; and in a frequency band of 5.05 GHz to 7.25 GHz, the antenna efficiency is −3.76 dB to −4.9 dB. FIG. 14 also shows test results of a pure metal antenna with the same structure and size. Compared with the pure metal antenna, the transparent antenna basically has no efficiency loss at a low frequency, and an efficiency loss at a high frequency is within 0.69 dB. In addition, compared with the existing antenna for AR glasses, the transparent antenna described in this application is far away from the human head, and thus can achieve higher efficiency.

The transparent antenna of the present disclosure does not occupy an internal space of the glasses, and does not need to open windows in a housing of the glasses, which not only ensures the integrity and beauty of the appearance of the AR glasses, but also reduces the volume of the AR glasses. The transmittance of the transparent antenna is determined by the transmittance of the adopted transparent metal, and the measured transmittance of the antenna embodiment of the present disclosure is 83.3%. In general, the transmittance and the conductivity of the transparent antenna are contradictory to each other, and the transmittance of the transparent antenna needs to be reduced in order to improve the antenna efficiency during actual design, while in the present disclosure, the antenna efficiency is improved without reducing the transmittance.

The various embodiments in the present specification are described in a parallel or progressive manner, each embodiment focuses on differences from other embodiments, and the same or similar parts between the various embodiments may be referred to each other. As for the device disclosed in the embodiment, since it corresponds to the method disclosed in the embodiment, the description is relatively simple. For relevant parts, please refer to the description of the method.

Those of ordinary skill in the art will understand that the units and algorithm steps of each example described in conjunction with the embodiments disclosed herein can be implemented by electronic hardware, computer software, or a combination thereof. In order to clearly explain the interchangeability of hardware and software, the composition and steps of each example have been generally described in the above description in terms of function. Whether these functions are performed in hardware or software depends on the specific application and design constraints of the technical solution. Those skilled in the art may implement the described functions for each specific application using different methods, but such implementations should not be considered beyond the scope of the present disclosure.

The steps of the method or algorithm described in connection with the embodiments disclosed herein may be directly implemented by hardware, a software module executed by a processor, or a combination thereof. The software module may be disposed in a random-access memory (RAM), a memory, a read-only memory (ROM), an electrically programmable ROM, an electrically erasable programmable ROM, a register, a hard disk, a removable disk, a CD-ROM, or any other form of storage medium known in the art.

It should be noted that relational terms such as first and second described herein are only used to distinguish one entity or operation from another entity or operation, and do not necessarily require or imply any such actual relationship or order between these entities or operations. Moreover, terms such as “comprise”, “include” or any other variation thereof are intended to encompass a non-exclusive inclusion such that a process, method, article or apparatus that includes a series of elements includes not only those elements, but also other elements not explicitly listed, or elements inherent to such a process, method, article or apparatus. Without further limitation, the element defined by the phrase “including a . . . ” does not preclude the presence of additional identical elements in the process, method, article or apparatus including the element.

1. An antenna structure, applied to intelligent wearable glasses including a lens, comprising:
a carrier having a first side surface and a second side surface arranged opposite each other, the first side surface being configured to be fixed to the lens;
an antenna ground arranged on the second side surface of the carrier; and
a wideband monopole arranged on the second side surface of the carrier, the wideband monopole being coupled to the antenna ground.

2. The antenna structure of claim 1, wherein the carrier has a shape adapted to that of the lens;
the antenna ground is disposed close to a side edge of the carrier; and
the wideband monopole is disposed on a side of the carrier away from the side edge.

3. The antenna structure of claim 1, wherein the antenna ground is disposed around a side edge of the carrier.

4. The antenna structure of claim 1, wherein the antenna ground comprises:
a coupling portion, wherein a gap is formed between the coupling portion and the wideband monopole; and
a metal ring, wherein two ends of the metal ring are connected to the coupling portion, and the metal ring is disposed around a side edge of the carrier.

5. The antenna structure of claim 4, wherein the antenna ground further comprises:
a capacitive loading stub disposed on a side of the carrier close to the side edge, wherein the capacitive loading stub is electrically connected to the metal ring, and the capacitive loading stub is configured to match impedance.

6. The antenna structure of claim 5, wherein the capacitive loading stub is made of metal mesh.

7. The antenna structure of claim 4, wherein the coupling portion is U-shaped, and an opening of the coupling portion is disposed at a position corresponding to the wideband monopole.

8. The antenna structure of claim 4, wherein the coupling portion comprises a metal layer, an ACF conductive film layer, and a flexible circuit board layer that are sequentially stacked on the carrier; wherein,
the metal layer is electrically connected to the metal ring; and
the flexible circuit board layer is configured to be electrically connected to an outer conductor of a coaxial cable.

9. The antenna structure of claim 1, wherein the wideband monopole comprises:
a feeding coplanar waveguide, wherein a gap is formed between the feeding coplanar waveguide and the antenna ground, and the feeding coplanar waveguide is configured to implement signal transmission; and
a radiation stub electrically connected to the feeding coplanar waveguide, and the radiation stub is configured to match wideband impedance.

10. The antenna structure of claim 9, wherein the radiation stub comprises a main stub, a first stub, and a second stub, wherein a first end of the main stub is electrically connected to the feeding coplanar waveguide, and a second end of the main stub is electrically connected to the first stub and the second stub.

11. The antenna structure of claim 10, wherein a length of the first stub is greater than a length of the second stub.

12. The antenna structure of claim 9, wherein the radiation stub is made of metal mesh.

13. The antenna structure of claim 9, wherein the feeding coplanar waveguide comprises a metal layer, an ACF conductive film layer, and a flexible circuit board layer that are sequentially stacked on the carrier; wherein:
the metal layer is electrically connected to the radiation stub;
the flexible circuit board layer is configured to be electrically connected to an inner conductor of a coaxial cable.

14. Intelligent wearable glasses, comprising:
a frame;
a lens disposed in the frame; and
the antenna structure of claim 1, wherein the antenna structure is disposed on the lens.

15. The antenna structure of claim 1, wherein the carrier comprises at least one selected from a group consisting of a thin film material, a blue light film, a dustproof film and a polyethylene terephthalate (PET) film.

16. The antenna structure of claim 5, wherein the capacitive loading stub is disposed at the farthest distance from the wideband monopole.

17. The antenna structure of claim 5, wherein the capacitive loading stub having an increased area is used as a size of the lens increases.

18. The antenna structure of claim 10, wherein the main stub extends toward an inside of the lens and extends in different directions to form the first stub and the second stub.

19. The intelligent wearable glasses of claim 18, wherein the antenna ground comprises a portion hidden in the frame.

20. The intelligent wearable glasses of claim 19, wherein the portion hidden in the frame comprises an opaque metal and the antenna ground further comprises an exposed portion comprising a metal mesh.
